(19) United States
(12) Patent Application Publication
(10) Pub. No.: US 2025/0278639 A1
(43) Pub. Date: Sep. 4, 2025

(54) SYSTEMS AND METHODS FOR UTILIZING A COST ESTIMATION MODEL TO GENERATE RANKED CONTEXTUAL COUNTERFACTUALS

(71) Applicant: Verizon Patent and Licensing Inc., Basking Ridge, NJ (US)

(72) Inventors: Praveenkumar CHANDRASEKARAN, Chennai (IN); Karthik SADHASIVAM, Kumbakonam (IN)

(73) Assignee: Verizon Patent and Licensing Inc., Basking Ridge, NJ (US)

(21) Appl. No.: 18/591,688

(22) Filed: Feb. 29, 2024

(51) Int. Cl. G06N 5/01

(52) U.S. Cl. CPC G06N 5/01

(57) ABSTRACT

A device may receive a trained model, training data utilized to train the trained model, and a query associated with generating counterfactuals, and may utilize a counterfactual model to generate counterfactuals for the trained model based on the training data and the query. The device may determine contextual parameters associated with ranking the counterfactuals, and may utilize a counterfactual ranking model to calculate a weighted metric based on the query, the counterfactuals, and the contextual parameters. The device may utilize the counterfactual ranking model to apply the weighted metric to the counterfactuals to generate ranked counterfactuals for the trained model, and may perform one or more actions based on the ranked counterfactuals.

### BACKGROUND

In the context of explainable artificial intelligence techniques, a counterfactual (or a counterfactual explanation) refers to an explanation that highlights minimal changes needed in input data for a model (e.g., a machine learning model) in order to alter an output of the model.

### BRIEF DESCRIPTION OF THE DRAWINGS

FIGS. 1A-1G are diagrams of an example associated with utilizing a cost estimation model to generate ranked contextual counterfactuals.

FIG. 2 is a diagram of an example environment in which systems and/or methods described herein may be implemented.

FIG. 3 is a diagram of example components of one or more devices of FIG. 2.

FIG. 4 is a flowchart of an example process for utilizing a cost estimation model to generate ranked contextual counterfactuals.

### DETAILED DESCRIPTION OF EXAMPLE EMBODIMENTS

The following detailed description of example implementations refers to the accompanying drawings. The same reference numbers in different drawings may identify the same or similar elements.

Machine learning models are increasingly being used to inform decisions across various domains, such as finance, healthcare, education, criminal justice, and/or the like. In the telecommunications industry, machine learning models can predict network maintenance requirements, network management suggestions, customer behavior (e.g., a likelihood of a subscriber to continue using services), and/or the like. Counterfactuals are essential for understanding and acting upon predictions generated by machine learning models. However, current techniques for generating multiple counterfactuals for a single input pose a significant challenge. For example, while existing techniques produce several counterfactuals for an input, there is no established method for systematically ranking these counterfactuals based on their relevance, cost (e.g., cost associated with a model output that is generated based on a counterfactual), quality, and/or the like. Thus, current techniques for generating multiple counterfactuals for a single input consume computing resources (e.g., processing resources, memory resources, communication resources, and/or the like), networking resources, and/or other resources associated with generating counterfactuals that are too expensive to implement, generating counterfactuals that are less relevant than other counterfactuals, generating counterfactuals that are of lesser quality than other counterfactuals, modifying a network or a device based on less optimal counterfactuals, and/or the like.

Some implementations described herein provide a ranking system that utilizes a cost estimation model (e.g., a model that estimates costs associated with model outputs generated based on counterfactuals) to generate ranked contextual counterfactuals. For example, the ranking system may systematically rank counterfactuals generated by a machine learning model to enable more effective decision-making in domains, such as telecommunications. The ranking system may receive a trained model, training data, and a query for generating counterfactuals, and may utilize the counterfactual model to generate counterfactuals based on the query. The ranking system may determine contextual parameters for ranking the counterfactuals, and may utilize a counterfactual ranking model to calculate a weighted metric, which is applied to rank the counterfactuals. The ranking system may utilize the ranked counterfactuals to perform one or more actions, such as maintaining a network or integrating the one or more actions into real-time decision support systems.

In this way, the ranking system utilizes a cost estimation model to generate ranked contextual counterfactuals. For example, the ranking system may select the most relevant and technically efficacious counterfactuals from multiple counterfactuals generated for a single input query. The ranking system may rank the counterfactuals based on technical criteria, such as computational costs associated with implementing the counterfactuals, similarity of the counterfactuals to the query, and effect the counterfactuals on a predicted outcome. By calculating metrics that reflect these technical factors and by applying weights, the ranking system generates ranked counterfactuals tailored to specific technical objectives. Thus, the ranking system may conserve computing resources, networking resources, and/or other resources that would have otherwise been consumed by generating counterfactuals that are too expensive to implement, generating counterfactuals that are less relevant than other counterfactuals, generating counterfactuals that are of lesser quality than other counterfactuals, modifying a network or a device based on less optimal counterfactuals, and/or the like. The ranking system may streamline decision-making processes, optimize use of computational assets, and reduce a need for extensive manual analysis. The ranking system may enhance efficiencies of machine learning models in providing actionable insights, leading to optimized operational workflows and resource allocation in various technical applications.

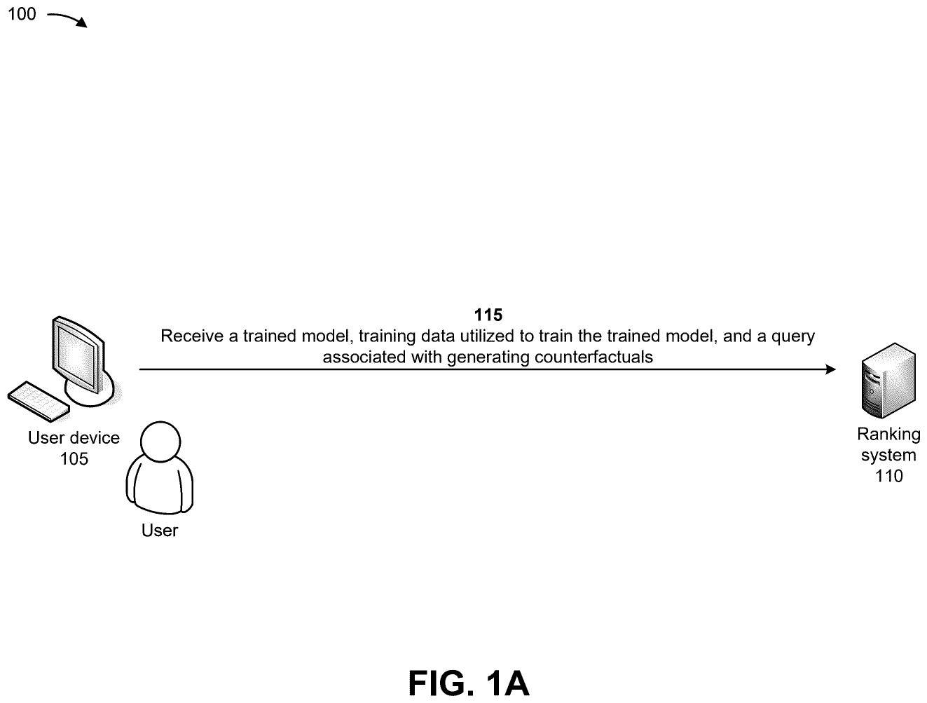

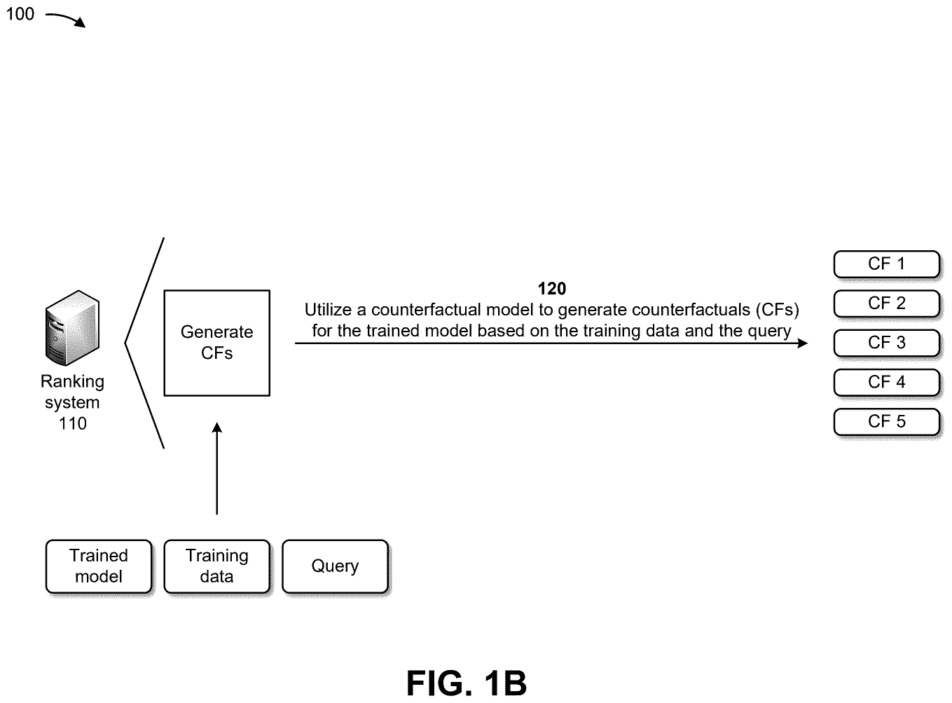

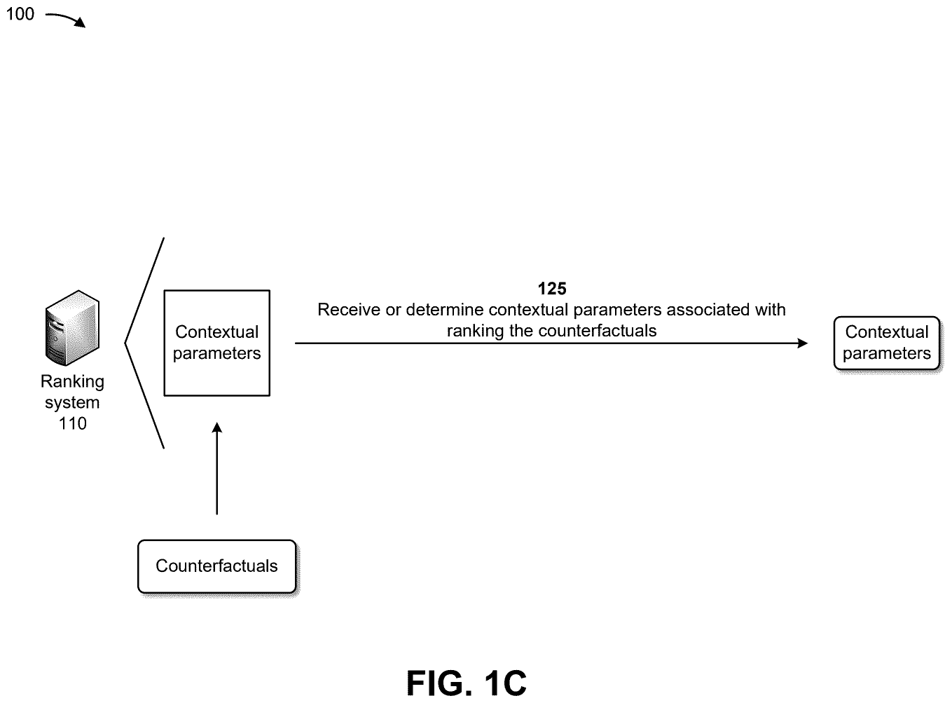

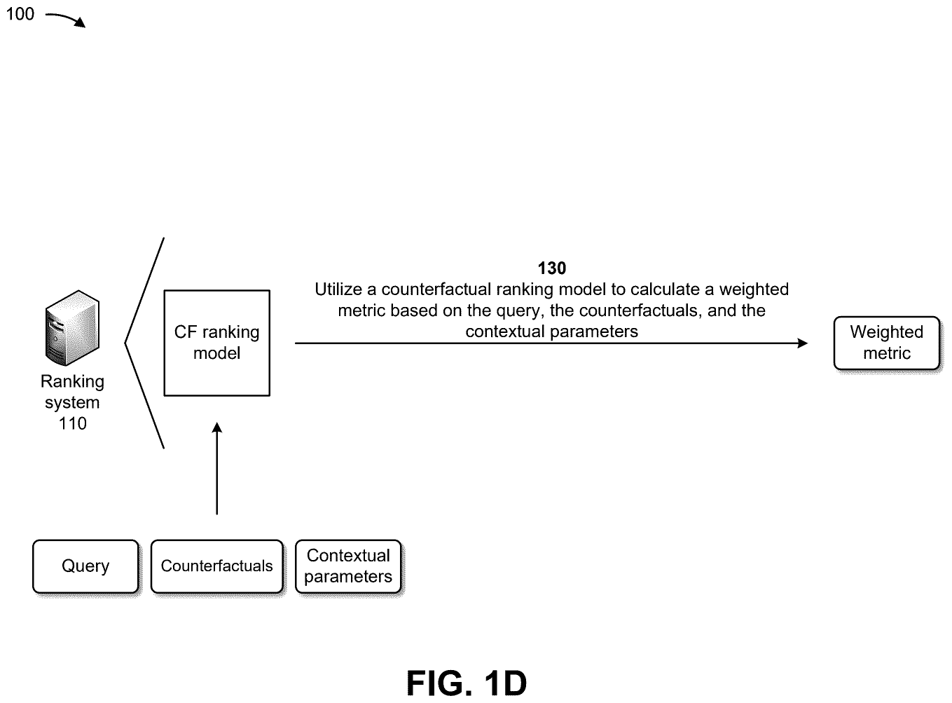

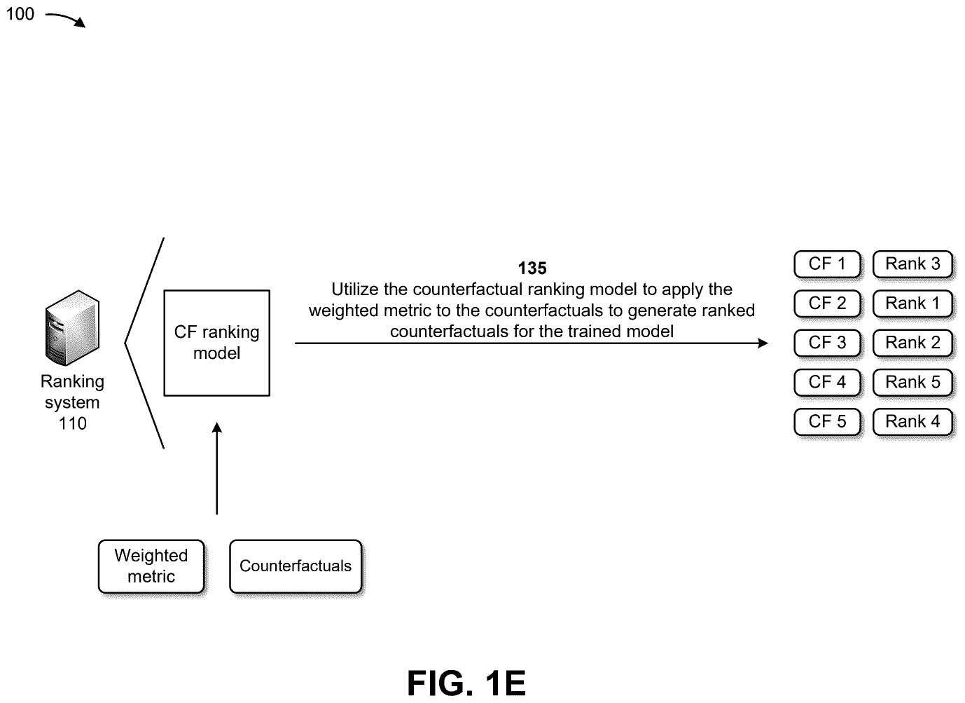

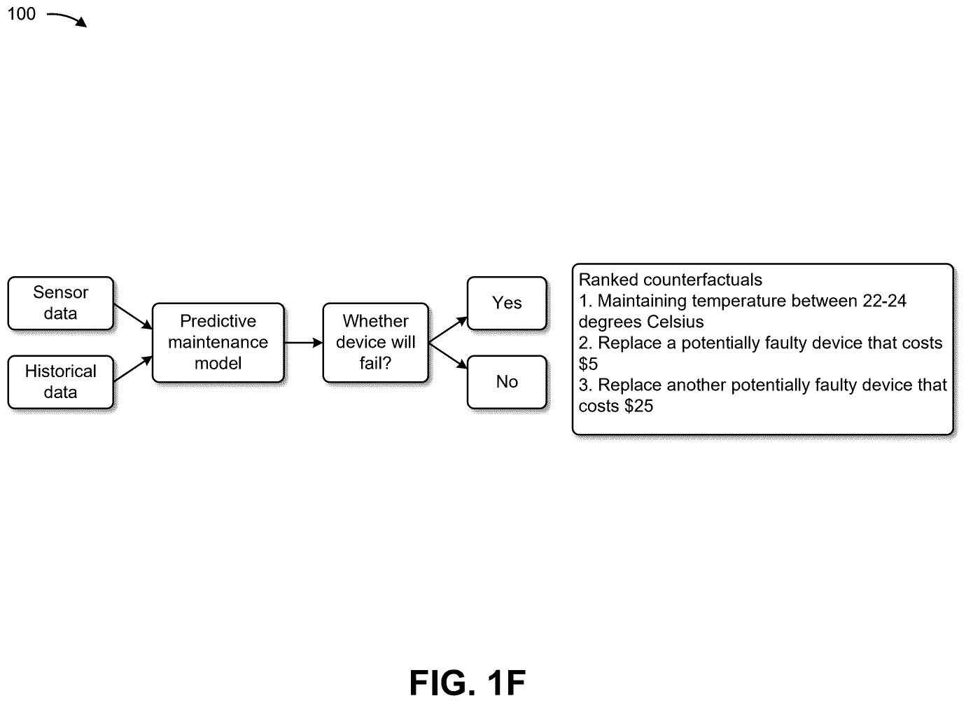

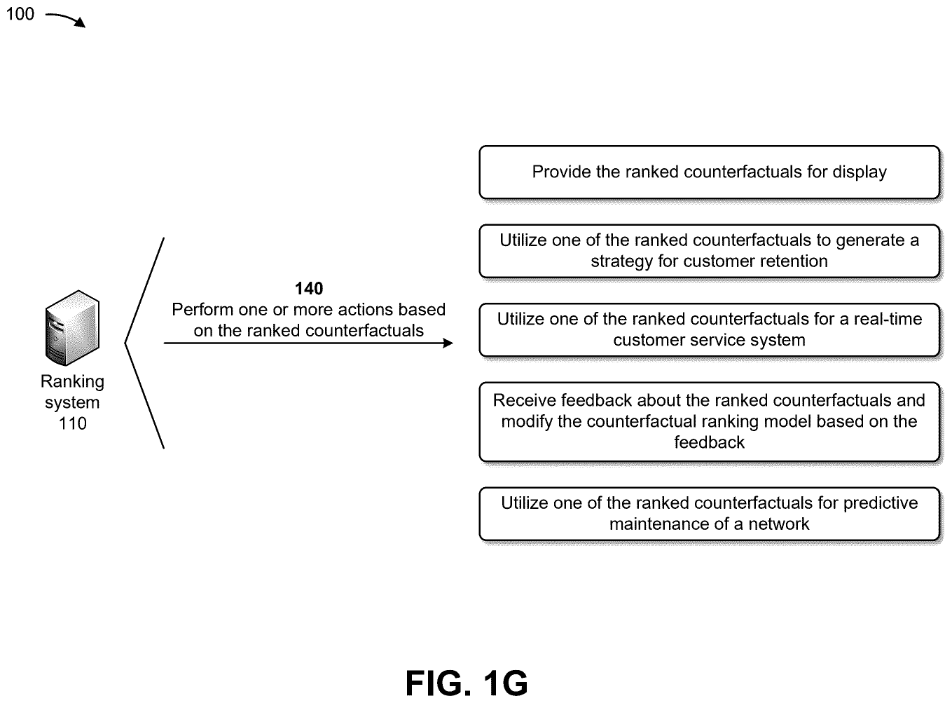

FIGS. 1A-1G are diagrams of an example 100 associated with utilizing a cost estimation model to generate ranked contextual counterfactuals. As shown in FIGS. 1A-1G, example 100 includes a user device 105 associated with a user and a ranking system 110. Further details of the user device 105 and the ranking system 110 are provided elsewhere herein.

As shown in FIG. 1A, and by reference number 115, the ranking system 110 may receive a trained model, training data utilized to train the trained model, and a query associated with generating counterfactuals. For example, the ranking system 110 may receive a trained model (e.g., a trained machine learning model) for which counterfactuals are to be generated and utilized to understand and act upon predictions generated by the trained model. In some implementations, the user may utilize the user device 105 to provide the trained model to the ranking system 110, and the ranking system 110 may receive the trained model from the user device 105. The user may utilize training data to train a model and to generate the trained model. The user may utilize the user device 105 to provide the training data to the ranking system 110, and the ranking system 110 may receive the training data from the user device 105. In one example, the training data may include data used to teach the model how to extract features that are relevant to specific goals; data used to fit the model; a representative sample of training data; a minimum or maximum value of features in case of confidential data; and/or the like. The user may utilize the user device 105 to provide the query (e.g., an input with a predicted label) associated with generating counterfactuals to the ranking system 110, and the ranking system 110 may receive the query from the user device 105.

As shown in FIG. 1B, and by reference number 120, the ranking system 110 may utilize a counterfactual model to generate counterfactuals (CFs) for the trained model based on the training data and the query. For example, the ranking system 110 may include or be associated a counterfactual model that generates counterfactuals for a model. The ranking system 110 may process the trained model, the training data, and the query, with the counterfactual model, to generate the counterfactuals. In some implementations, the counterfactual model may include a Rubin causal model (RCM), also known as a Neyman-Rubin causal model. In some implementations, the counterfactual model may include a search model and components that perturb features of a query set and infers a perturbed query set to the model to generate the counterfactuals of an expected class (e.g., for binary classification or multiple classification). Multiple counterfactuals can be generated for a single query. As further shown, the counterfactual model may generate a first counterfactual (CF 1), a second counterfactual (CF 2), a third counterfactual (CF 3), a fourth counterfactual (CF 4), and a fifth counterfactual (CF 5).

As shown in FIG. 1C, and by reference number 125, the ranking system 110 may receive or determine contextual parameters associated with ranking the counterfactuals. For example, the user of the user device 105 may generate contextual parameters associated with ranking the counterfactuals, and may cause the user device 105 to provide the contextual parameters to the ranking system 110. The ranking system 110 may receive the contextual parameters associated with ranking the counterfactuals from the user device 105. Alternatively, or additionally, the ranking system 110 may determine the contextual parameters associated with ranking the counterfactuals. The contextual parameters may include a list of controllable variables, ranking weights based on an objective (e.g., default weights or custom weights), a method for calculating a distance measure, a quantity of top counterfactuals to be filtered, and/or the like. The ranking weights may include a first weight (w1) associated with perturbed features of counterfactuals, a second weight (w2) associated with a distance of the counterfactuals from the query, a third weight (w3) associated with a change in predicted probability for the counterfactuals, and/or the like.

As shown in FIG. 1D, and by reference number 130, the ranking system 110 may utilize a counterfactual ranking model to calculate a weighted metric based on the query, the counterfactuals, and the contextual parameters. For example, the ranking system 110 may include a counterfactual ranking model that ranks the counterfactuals generated by the counterfactual model based on the query, the counterfactuals, and the counterfactual parameters. In some implementations, the counterfactual ranking model may calculate the weighted metric based on the query, the counterfactuals and the counterfactual parameters. When utilizing the counterfactual ranking model to calculate the weighted metric, the ranking system 110 may calculate a cost metric for the counterfactuals, may calculate similarity metric for the counterfactuals, and may calculate an outcome effect metric for the counterfactuals. The weighted metric may correspond to a weighted combination of the cost metric, the similarity metric, and the outcome effect metric. In some implementations, the weighted metric may be based on costs associated with implementing the counterfactuals, similarities of the counterfactuals to the query, and effects of the counterfactuals on a predicted outcome.

In some implementations, when utilizing the counterfactual ranking model to calculate the weighted metric, the ranking system 110 may calculate a first metric (m1) that represents a quantity of perturbed features between the query and each of the counterfactuals, and may calculate a second metric (m2) that represents a spatial distance between the query and each of the counterfactuals. The ranking system 110 may calculate a third metric (m3) that represents a difference in a probability value between the query and each of the counterfactuals, and may normalize the first metric, the second metric, and the third metric to generate a normalized first metric, a normalized second metric, and a normalized third metric, respectively. The ranking system 110 may calculate the weighted metric based on the normalized first metric (m1), the normalized second metric (m2), the normalized third metric (m3), the first weight (w1), the second weight (w2), and the third weight (w3), as follows: 1−(w1*m1+w2*m2+w3*m3). In some implementations, when utilizing the counterfactual ranking model to calculate the weighted metric, the ranking system 110 may calculate metrics (e.g., the normalized first metric (m1), the normalized second metric (m2), and the normalized third metric (m3)) based on the query, the counterfactuals, and the contextual parameters, and may apply ranking weights (e.g., the first weight (w1), the second weight (w2), and the third weight (w3)) to the metrics to calculate the weighted metric. In some implementations, a different weighted metric may be calculated for each of the counterfactuals.

As shown in FIG. 1E, and by reference number 135, the ranking system 110 may utilize the counterfactual ranking model to apply the weighted metric to the counterfactuals to generate ranked counterfactuals for the trained model. For example, the ranking system 110 may apply a corresponding weighted metric to each of the counterfactuals to generate a different rank for each of the counterfactuals. As further shown, for example, the first counterfactual (CF 1) may include a rank of three, the second counterfactual (CF 2) may include a rank of one, the third counterfactual (CF 3) may include a rank of two, the fourth counterfactual (CF 4) may include a rank of five, and the fifth counterfactual (CF 5) may include a rank of four. Thus, the second counterfactual may be the top-ranked counterfactual, and the fourth counterfactual may be the lowest-ranked counterfactual.

FIG. 1F depicts an example use case for utilizing ranked counterfactuals. The ranked counterfactuals may be utilized for applications where predictive modeling and prescriptive analytics are to be applied to affect an outcome. For example, in a network domain, the ranked counterfactuals may be utilized for predictive maintenance of network devices, where prescriptions may be indicated by counterfactuals, such as to replace faulty minor parts causing the network devices to fail or a change in the weather causing the network devices to fail. The counterfactual model may generate counterfactuals, such as maintaining a temperature for the network devices between 22 and 24 degrees Celsius, replacing a faulty network device that costs $5.00, or replacing another faulty network device that costs $25.00. The ranking system 110 may rank the counterfactuals to apply the prescription based on costs. In this example, the ranking system 110 may rank maintaining a temperature for the network devices between 22 and 24 degrees Celsius as a first counterfactual, replacing a faulty network device that costs $5.00 as a second counterfactual, an replacing another faulty network device that costs $25.00 as a third counterfactual. It takes less effort and is less expensive to control an environment for a network devices rather than replacing a network device. If controlling the environment is impossible, then the second counterfactual may be selected (e.g., since the cost of $5.00 is much less than the cost of $25.00).

In another example, a company may lose a customer (e.g., churn) or retain a customer (e.g., no churn) based on actions of the company, such as enrolling the customer in a rewards program, providing a trade-in value for a customer's device, or providing the customer a credit. The actions of the company may correspond to counterfactuals, and may indicate that a customer is less likely to churn if the trade-in value is increased and that a customer is less likely to churn if the customer receives credits twice in seven days even though the trade-in value is decreased and no reward enrollment is provided. A model may predict that the customer is relatively highly sensitive to the trade-in value, which can be observed by variations in the trade-in value of the counterfactuals. The model may also predict that if the company decreases the trade-in value to a particular number, the customer is likely to churn even when the customer is given a credit twice in seven days.

In some implementations, the ranked counterfactuals may assist a backend system with proactive treatment and prescriptive analytics for churn and/or call volume reduction, and may assist other systems with proactive treatment and prescriptive analytics to affect outcomes for many use cases where predictive models are utilized. For example, in a customer churn scenario of the telecommunications domain, the ranked counterfactuals may assist with making decisions on offers and/or customer retention campaigns based on a prescription provided by the ranked counterfactuals in changing an outcome from churn to no churn. Similarly, proactive treatment may be provided for groups where insights can be generated from the ranked counterfactuals which change an outcome from no churn to churn.

As shown in FIG. 1G, and by reference number 140, the ranking system 110 may perform one or more actions based on the ranked counterfactuals. In some implementations, performing the one or more actions includes the ranking system 110 providing the ranked counterfactuals for display. For example, the ranking system 110 may provide the ranked counterfactuals to the user device 105, and the user device 105 may display the ranked counterfactuals to the user. The user may utilize the ranking of the counterfactuals to select one of the counterfactuals for implementation. The user device 105 may highlight a top-ranked counterfactual explanation ready to be used for decision making by the user. The user device 105 may enable the user to adjust the contextual parameters and/or the weights, which in turn may adjust the rankings of the counterfactuals. In this way, the ranking system 110 conserves computing resources, networking resources, and/or other resources that would have otherwise been consumed by generating counterfactuals that are too expensive to implement.

In some implementations, performing the one or more actions includes the ranking system 110 utilizing one of the ranked counterfactuals to generate a strategy for customer retention. For example, the ranking system 110 may select a top-ranked counterfactual, and may utilize the top-ranked counterfactual to generate a strategy for customer retention. The strategy for customer retention may include providing a free service to a customer in order to retain the customer with another service. The ranking system 110 may implement the strategy in order to retain the customer. In this way, the ranking system 110 conserves computing resources, networking resources, and/or other resources that would have otherwise been consumed by utilizing counterfactuals that are less relevant than other counterfactuals.

In some implementations, performing the one or more actions includes the ranking system 110 utilizing one of the ranked counterfactuals for a real-time customer service system. For example, the ranking system 110 may be integrated with real-time a customer service system, and may provide the ranked counterfactuals for display to a customer care agent associated with the customer service system. The customer care agent may interact with the ranked counterfactuals, and may cause one or more of the ranked counterfactuals to be implemented for one or more customers. In this way, the ranking system 110 conserves computing resources, networking resources, and/or other resources that would have otherwise been consumed by utilizing counterfactuals that are of lesser quality than other counterfactuals.

In some implementations, performing the one or more actions includes the ranking system 110 receiving feedback about the ranked counterfactuals and modifying the counterfactual ranking model based on the feedback. For example, the ranking system 110 may receive feedback about the ranked counterfactuals from the user (e.g., via the user device 105). The feedback may indicate an effectiveness of selected ranked counterfactuals. The ranking system 110 may update the counterfactual ranking model based on the feedback received from the user to improve the counterfactual ranking model. In this way, the ranking system 110 conserves computing resources, networking resources, and/or other resources that would have otherwise been consumed by generating counterfactuals that are too expensive to implement.

In some implementations, performing the one or more actions includes the ranking system 110 utilizing one of the ranked counterfactuals for predictive maintenance of a network. For example, as described above in connection with FIG. 1F, the ranking system 110 may utilize the ranked counterfactuals for predictive maintenance of a network of network devices. The ranking system 110 may utilize the ranked counterfactuals to select a least costly course of action (e.g., control the environment of the network devices) compared to other courses of action (e.g., replacing a network device for $5.00 or $25.00). In this way, the ranking system 110 conserves computing resources, networking resources, and/or other resources that would have otherwise been consumed by generating counterfactuals that are of lesser quality than other counterfactuals.

In some implementations, the ranking system 110 may perform one or more other actions based on the ranked counterfactuals, such as receive user-defined weightings associated with ranking the counterfactuals, and adjust the weighted metric based on the user-defined weightings; and filter the ranked counterfactuals based on a threshold and to generate a subset of top ranked counterfactuals.

In this way, the ranking system 110 utilizes a cost estimation model to generate ranked contextual counterfactuals. For example, the ranking system 110 may select the most relevant and technically efficacious counterfactuals from multiple counterfactuals generated for a single input query. The ranking system 110 may rank the counterfactuals based on technical criteria, such as computational costs associated with implementing the counterfactuals, similarity of the counterfactuals to the query, and effect the counterfactuals on a predicted outcome. By calculating metrics that reflect these technical factors and by applying weights, the ranking system 110 generates ranked counterfactuals tailored to specific technical objectives. Thus, the ranking system 110 may conserve computing resources, networking resources, and/or other resources that would have otherwise been consumed by generating counterfactuals that are too expensive to implement, generating counterfactuals that are less relevant than other counterfactuals, generating counterfactuals that are of lesser quality than other counterfactuals, modifying a network or a device based on less optimal counterfactuals, and/or the like. The ranking system 110 may streamline decision-making processes, optimize use of computational assets, and reduce a need for extensive manual analysis. The ranking system 110 may enhance efficiencies of machine learning models in providing actionable insights, leading to optimized operational workflows and resource allocation in various technical applications.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

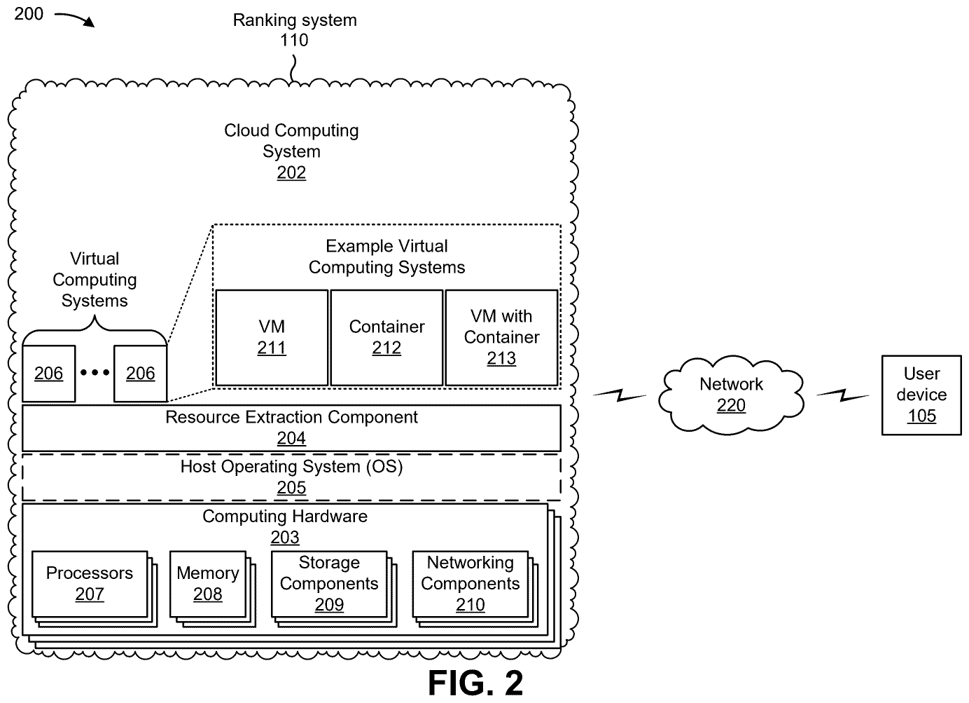

FIG. 2 is a diagram of an example environment 200 in which systems and/or methods described herein may be implemented. As shown in FIG. 2, the environment 200 may include the ranking system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 includes one or more devices capable of receiving, generating, storing, processing, and/or providing information, such as information described herein. For example, the user device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a network device (e.g., customer premises equipment (CPE), a label switching router (LSR), a label edge router (LER), an ingress router, an egress router, a provider router, a virtual router, a gateway, a switch, a firewall, a hub, a bridge, a reverse proxy, a load balancer, and/or the like), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

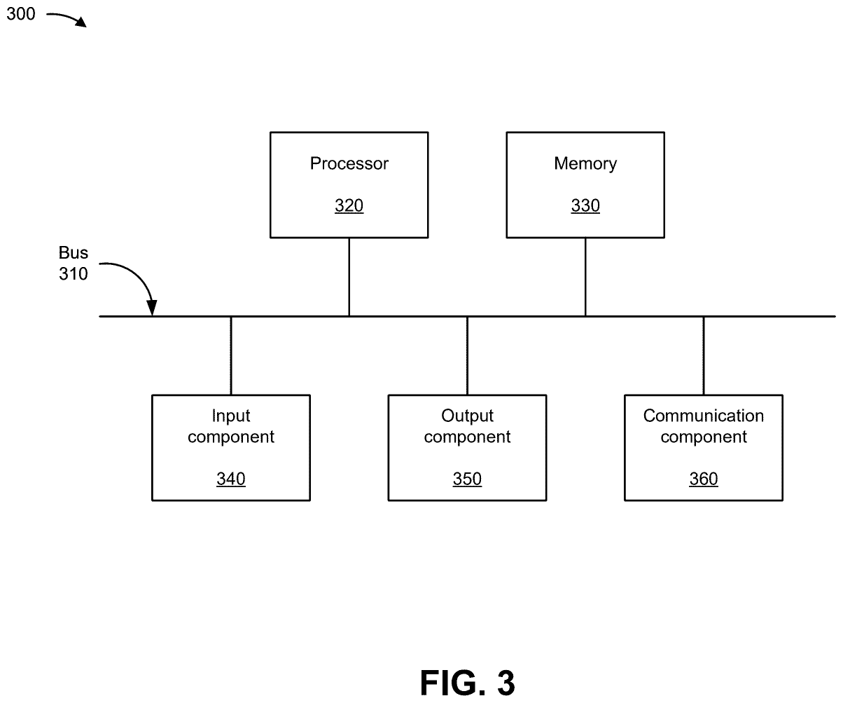

Although the ranking system 110 may include one or more elements 203-213 of the cloud computing system 202, may execute within the cloud computing system 202, and/or may be hosted within the cloud computing system 202, in some implementations, the ranking system 110 may not be cloud-based (e.g., may be implemented outside of a cloud computing system) or may be partially cloud-based. For example, the ranking system 110 may include one or more devices that are not part of the cloud computing system 202, such as the device 300 of FIG. 3, which may include a standalone server or another type of computing device. The ranking system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the ranking system 110. In some implementations, the user device 105 and/or the ranking system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

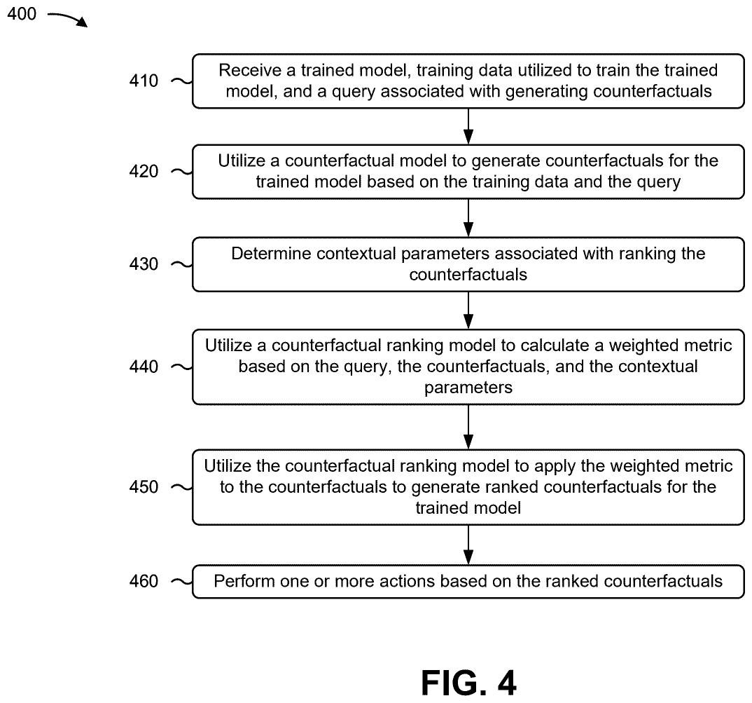

FIG. 4 is a flowchart of an example process 400 for utilizing a cost estimation model to generate ranked contextual counterfactuals. In some implementations, one or more process blocks of FIG. 4 may be performed by a device (e.g., the ranking system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a trained model, training data utilized to train the trained model, and a query associated with generating counterfactuals (block 410). For example, the device may receive a trained model, training data utilized to train the trained model, and a query associated with generating counterfactuals, as described above.

As further shown in FIG. 4, process 400 may include utilizing a counterfactual model to generate counterfactuals for the trained model based on the training data and the query (block 420). For example, the device may utilize a counterfactual model to generate counterfactuals for the trained model based on the training data and the query, as described above. In some implementations, each of the counterfactuals represents a minimal change in input data for the trained model to alter an output of the trained model.

As further shown in FIG. 4, process 400 may include determining contextual parameters associated with ranking the counterfactuals (block 430). For example, the device may determine contextual parameters associated with ranking the counterfactuals, as described above.

As further shown in FIG. 4, process 400 may include utilizing a counterfactual ranking model to calculate a weighted metric based on the query, the counterfactuals, and the contextual parameters (block 440). For example, the device may utilize a counterfactual ranking model to calculate a weighted metric based on the query, the counterfactuals, and the contextual parameters, as described above. In some implementations, the weighted metric is based on costs associated with implementing the counterfactuals, similarities of the counterfactuals to the query, and effects of the counterfactuals on a predicted outcome. In some implementations, utilizing the counterfactual ranking model to calculate the weighted metric includes calculating a cost metric for the counterfactuals, calculating a similarity metric for the counterfactuals, and calculating an outcome effect metric for the counterfactuals, wherein the weighted metric corresponds to a combination of the cost metric, the similarity metric, and the outcome effect metric.

In some implementations, utilizing the counterfactual ranking model to calculate the weighted metric includes calculating a first metric that represents a quantity of perturbed features between the query and each of the counterfactuals, calculating a second metric that represents a spatial distance between the query and each of the counterfactuals, calculating a third metric that represents a difference in a probability value between the query and each of the counterfactuals, normalizing the first metric, the second metric, and the third metric to generate a normalized first metric, a normalized second metric, and a normalized third metric, respectively, and calculating the weighted metric based on the normalized first metric, the normalized second metric, and the normalized third metric. In some implementations, utilizing the counterfactual ranking model to calculate the weighted metric includes calculating metrics based on the query, the counterfactuals, and the contextual parameters, and applying ranking weights to the metrics to calculate the weighted metric.

As further shown in FIG. 4, process 400 may include utilizing the counterfactual ranking model to apply the weighted metric to the counterfactuals to generate ranked counterfactuals for the trained model (block 450). For example, the device may utilize the counterfactual ranking model to apply the weighted metric to the counterfactuals to generate ranked counterfactuals for the trained model, as described above.

As further shown in FIG. 4, process 400 may include performing one or more actions based on the ranked counterfactuals (block 460). For example, the device may perform one or more actions based on the ranked counterfactuals, as described above. In some implementations, performing the one or more actions includes one or more of providing the ranked counterfactuals for display, or integrating the ranked counterfactuals in a real-time decision support system. In some implementations, performing the one or more actions includes one or more of utilizing one of the ranked counterfactuals to generate a strategy for customer retention, or utilizing one of the ranked counterfactuals for a real-time customer service system. In some implementations, performing the one or more actions includes receiving feedback about the ranked counterfactuals, and modifying a counterfactual ranking model based on the feedback. In some implementations, performing the one or more actions includes utilizing one of the ranked counterfactuals for predictive maintenance of a network.

In some implementations, process 400 includes receiving user-defined weightings associated with ranking the counterfactuals, and adjusting the weighted metric based on the user-defined weightings. In some implementations, process 400 includes filtering the ranked counterfactuals based on a threshold and to generate a subset of top ranked counterfactuals. In some implementations, process 400 includes normalizing the contextual parameters prior to utilizing the contextual parameters to calculate the weighted metric.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a trained model, training data utilized to train the trained model, and a query associated with generating counterfactuals;
utilizing, by the device, a counterfactual model to generate counterfactuals for the trained model based on the training data and the query;
determining, by the device, contextual parameters associated with ranking the counterfactuals;
utilizing, by the device, a counterfactual ranking model to calculate a weighted metric based on the query, the counterfactuals, and the contextual parameters;
utilizing, by the device, the counterfactual ranking model to apply the weighted metric to the counterfactuals to generate ranked counterfactuals for the trained model; and
performing, by the device, one or more actions based on the ranked counterfactuals.

2. The method of claim 1, further comprising:
receiving user-defined weightings associated with ranking the counterfactuals; and
adjusting the weighted metric based on the user-defined weightings.

3. The method of claim 1, further comprising:
filtering the ranked counterfactuals based on a threshold and to generate a subset of top ranked counterfactuals.

4. The method of claim 1, wherein the weighted metric is based on costs associated with implementing the counterfactuals, similarities of the counterfactuals to the query, and effects of the counterfactuals on a predicted outcome.

5. The method of claim 1, wherein utilizing the counterfactual ranking model to calculate the weighted metric comprises:
calculating a cost metric for the counterfactuals;
calculating a similarity metric for the counterfactuals; and
calculating an outcome effect metric for the counterfactuals,
wherein the weighted metric corresponds to a combination of the cost metric, the similarity metric, and the outcome effect metric.

6. The method of claim 1, wherein utilizing the counterfactual ranking model to calculate the weighted metric comprises:
calculating a first metric that represents a quantity of perturbed features between the query and each of the counterfactuals;
calculating a second metric that represents a spatial distance between the query and each of the counterfactuals;
calculating a third metric that represents a difference in a probability value between the query and each of the counterfactuals;
normalizing the first metric, the second metric, and the third metric to generate a normalized first metric, a normalized second metric, and a normalized third metric, respectively; and
calculating the weighted metric based on the normalized first metric, the normalized second metric, and the normalized third metric.

7. The method of claim 1, wherein utilizing the counterfactual ranking model to calculate the weighted metric comprises:
calculating metrics based on the query, the counterfactuals, and the contextual parameters; and
applying ranking weights to the metrics to calculate the weighted metric.

8. A device, comprising:
one or more processors configured to:
receive a trained model, training data utilized to train the trained model, and a query associated with generating counterfactuals;
generate counterfactuals for the trained model based on the training data and the query;
determine contextual parameters associated with ranking the counterfactuals;
calculate a weighted metric based on the query, the counterfactuals, and the contextual parameters;
apply the weighted metric to the counterfactuals to generate ranked counterfactuals for the trained model; and
perform one or more actions based on the ranked counterfactuals.

9. The device of claim 8, wherein each of the counterfactuals represents a minimal change in input data for the trained model to alter an output of the trained model.

10. The device of claim 8, wherein the one or more processors are further configured to:
normalize the contextual parameters prior to utilizing the contextual parameters to calculate the weighted metric.

11. The device of claim 8, wherein the one or more processors, to perform the one or more actions, are configured to one or more of:
provide the ranked counterfactuals for display; or
integrate the ranked counterfactuals in a real-time decision support system.

12. The device of claim 8, wherein the one or more processors, to perform the one or more actions, are configured to one or more of:
utilize one of the ranked counterfactuals to generate a strategy for customer retention; or
utilize one of the ranked counterfactuals for a real-time customer service system.

13. The device of claim 8, wherein the one or more processors, to perform the one or more actions, are configured to:
receive feedback about the ranked counterfactuals; and
modify a counterfactual ranking model based on the feedback.

14. The device of claim 8, wherein the one or more processors, to perform the one or more actions, are configured to:
utilize one of the ranked counterfactuals for predictive maintenance of a network.

15. A non-transitory computer-readable medium storing a set of instructions, the set of instructions comprising:
one or more instructions that, when executed by one or more processors of a device, cause the device to:
receive a trained model, training data utilized to train the trained model, and a query associated with generating counterfactuals;
utilize a counterfactual model to generate counterfactuals for the trained model based on the training data and the query,
wherein each of the counterfactuals represents a minimal change in input data for the trained model to alter an output of the trained model;
determine contextual parameters associated with ranking the counterfactuals;
utilize a counterfactual ranking model to calculate a weighted metric based on the query, the counterfactuals, and the contextual parameters;
utilize the counterfactual ranking model to apply the weighted metric to the counterfactuals to generate ranked counterfactuals for the trained model; and
perform one or more actions based on the ranked counterfactuals.

16. The non-transitory computer-readable medium of claim 15, wherein the one or more instructions further cause the device to:
receive user-defined weightings associated with ranking the counterfactuals; and
adjust the weighted metric based on the user-defined weightings.

17. The non-transitory computer-readable medium of claim 15, wherein the one or more instructions further cause the device to:
filter the ranked counterfactuals based on a threshold and to generate a subset of top ranked counterfactuals.

18. The non-transitory computer-readable medium of claim 15, wherein the one or more instructions, that cause the device to utilize the counterfactual ranking model to calculate the weighted metric, cause the device to:
calculate a cost metric for the counterfactuals;
calculate a similarity metric for the counterfactuals; and
calculate an outcome effect metric for the counterfactuals,
wherein the weighted metric corresponds to a combination of the cost metric, the similarity metric, and the outcome effect metric.

19. The non-transitory computer-readable medium of claim 15, wherein the one or more instructions, that cause the device to utilize the counterfactual ranking model to calculate the weighted metric, cause the device to:
calculate a first metric that represents a quantity of perturbed features between the query and each of the counterfactuals;
calculate a second metric that represents a spatial distance between the query and each of the counterfactuals;
calculate a third metric that represents a difference in a probability value between the query and each of the counterfactuals;
normalize the first metric, the second metric, and the third metric to generate a normalized first metric, a normalized second metric, and a normalized third metric, respectively; and
calculate the weighted metric based on the normalized first metric, the normalized second metric, and the normalized third metric.

20. The non-transitory computer-readable medium of claim 15, wherein the one or more instructions, that cause the device to utilize the counterfactual ranking model to calculate the weighted metric, cause the device to:
calculate metrics based on the query, the counterfactuals, and the contextual parameters; and
apply ranking weights to the metrics to calculate the weighted metric.
